(19) United States
(12) Patent Application Publication
(10) Pub. No.: US 2025/0140463 A1
(43) Pub. Date: May 1, 2025

(54) FLAT MULTI-PHASE INDUCTOR

(71) Applicant: ITG ELECTRONICS, INC., Elmsford, NY (US)

(72) Inventors: Martin KUO, Elmsford, NY (US); Nanhai ZHU, Elmsford, NY (US)

(73) Assignee: ITG ELECTRONICS, INC., Elmsford, NY (US)

(21) Appl. No.: 18/384,177

(22) Filed: Oct. 26, 2023

(51) Int. Cl. H01F 17/04; H01F 27/28

(52) U.S. Cl. CPC H01F 17/04; H01F 27/28

(57) ABSTRACT

A flat multi-phase inductor is provided. The flat multi-phase inductor includes a main iron core, a plurality of first coils, a plurality of second coils and a plurality of secondary iron core. The main iron core has a plurality of accommodating spaces, the plurality of first coils are respectively disposed in the plurality of accommodating spaces. The plurality of second coils are respectively disposed in the spaces defined by the plurality of first coils, and the plurality of secondary iron core are respectively disposed in the spaces defined by the plurality of second coils. The second coil includes a series part, and the series part connects two adjacent second coils to each other in a regular manner. The secondary iron core, the second coil and the first coil are correspondingly disposed in a plurality of accommodating spaces of the main iron core to form an inductor element.

### FIELD OF THE DISCLOSURE

The present disclosure relates to a multi-phase inductor, and more particularly to a flat, uncoupled multi-phase inductor in which second coils are connected in series.

### BACKGROUND OF THE DISCLOSURE

Existing inductor elements are generally single-phase inductor elements with independent applications, so that a coupling between independent inductor elements is easy to occur. Spaces are required between independent inductive elements and gaps are required during the inductive element assembly process, thereby increasing the volume of the electronic device and decreasing the working efficiency. A simple mechanical method is adopted only for a very small number of inductors to directly bond multiple inductor elements into one. However, such inductors are usually bulky, heavy, and high in height, which increases a collapsing chance during operation. The current trend of electronic equipment development is to improve the efficiency and reduce the size, so it is necessary to reduce an overall size of the inductor and reduce the chance of collapse of the inductor.

### SUMMARY OF THE DISCLOSURE

In response to the above-referenced technical inadequacies, the present disclosure provides a flat multi-phase inductor, which can improve the deficiencies of existing technologies. The advantages of the present disclosure are described below. Firstly, the multiple inductor elements are not coupled with each other and can be applied independently without interfering with each other. Secondly, a height of the flat multi-phase inductor is smaller than a length or a width of the flat multi-phase inductor, so that the flat multi-phase inductor is not easy to collapse and displace during operation. Last but not least, the coils connect the second coils in series, which increases reliability of the flat multi-phase inductor of the present disclosure.

In order to solve the above-mentioned problems, one of the technical aspects adopted by the present disclosure is to provide a flat multi-phase inductor, which includes a main iron core, a plurality of first coils, a plurality of second coils and a plurality of secondary iron cores. The main iron core has a plurality of accommodating spaces, the plurality of first coils are respectively disposed in the plurality of accommodating spaces, the plurality of second coils are respectively disposed in spaces defined by the plurality of first coils, and the plurality of secondary iron cores are respectively disposed in spaces defined by the plurality of second coils. The plurality of secondary iron cores, the plurality of second coils and the plurality of first coils are correspondingly disposed in the plurality of accommodating spaces of the main iron core to form an inductor element.

In certain embodiments, each of the plurality of secondary iron core has an assembly surface and two assembly sides, each of the plurality of first coils has a first cross beam, each of two ends of the first cross beams has a first cross beam extension part bent perpendicular to a direction of the first cross beam; each of the plurality of second coils has a second cross beam, each of two ends of the second cross beams respectively have a second cross beam extension part bent perpendicular to a direction of the second cross beam.

In certain embodiments, the first cross beam of the first coils has a first cross beam outer surface and a first cross beam inner surface, the first cross beam extension parts has a first cross beam extension part outer surface and a first cross beam extension part inner surface, the second cross beam of the second coil has a second cross beam outer surface and a second cross beam inner surface, and each of the second cross beam extension parts has a second cross beam extension part outer surface and a second cross beam extension part inner surface.

In certain embodiments, the assembly surface of each of the secondary iron cores complements with a corresponding one of the second cross beam inner surfaces of the second coils, the two assembly sides of each of the plurality of secondary iron cores respectively complements with a corresponding pair of the second cross beam extension part inner surface of the second coils, the secondary cross beam outer surface of each of the secondary iron cores complements with a corresponding one of the first cross beam inner surface of the first coils, and the two second cross beam extension part outer surfaces of each of the second coils respectively complements with a corresponding pair of the first cross beam inner surface of the first coils.

In certain embodiments, each of the plurality of accommodating spaces has an accommodating space inner wall and two accommodating space inner side walls, and the first cross beam outer surface of the first coils complements with a corresponding one of the accommodating space inner wall.

In certain embodiments, each of the plurality of secondary iron cores and a corresponding one of the second coils has a first gap therebetween, each of the plurality of second coils and a corresponding one of the first coils has a second gap therebetween, each of plurality of the first coils and a corresponding one of the accommodating spaces has a third gap therebetween, and each of the plurality of secondary iron cores and a corresponding one of the accommodating space inner side wall has a fourth gap therebetween.

In certain embodiments, the plurality of first coils and the plurality of second coils are made of a copper sheet or a conductive material by stamping or bending, and wherein the plurality of first coils are gate-shaped or [symbol] -shaped coils.

In certain embodiments, each of the plurality of second coils includes at least one series part, the series part connects adjacent second coils with each other in a regular manner, a plurality of second coil accommodating spaces are correspondingly defined by the series part and the second coils, and each of the plurality of secondary iron cores are respectively disposed in the plurality of second coil accommodating spaces.

In certain embodiments, each of the plurality of secondary iron cores has an assembly member, and the assembly member is correspondingly installed on the series part.

In certain embodiments, the flat multi-phase inductor is a two-phase inductor, a three-phase inductor or a four-phase inductor.

In certain embodiments, a height of the flat multi-phase inductor is smaller than a length or a width of the flat multi-phase inductor.

One of the beneficial effects of the present disclosure is that, in the flat multi-phase inductor provided by the present disclosure, by virtue of “the height of the flat multi-phase inductor is much smaller than the length or the width of the flat multi-phase inductor,” stability of the flat multi-phase inductor during operation can be achieved, and the flat multi-phase inductor is not easy to collapse or displace. Another beneficial effect is that, the reliability of the overall flat multi-phase inductor is increased through the technical solution of “connecting the plurality of second coils to each other in a regular manner by the series part of the plurality of second coils”.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic exploded view of a flat multi-phase inductor according to a first embodiment of the present disclosure;

FIG. 2 is a schematic assembled view of the flat multi-phase inductor according to the first embodiment of the present disclosure;

FIG. 3 is a schematic cross-sectional view taken along line III-III of FIG. 2;

FIG. 4 is a schematic cross-sectional view taken along line IV-IV of FIG. 2;

FIG. 5 is a schematic exploded diagram of the flat multi-phase inductor according to a second embodiment of the present disclosure;

FIG. 6 is a schematic exploded diagram of the flat multi-phase inductor according to a third embodiment of the present disclosure; and

FIG. 7 is a schematic exploded diagram of the flat multi-phase inductor according to a fourth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

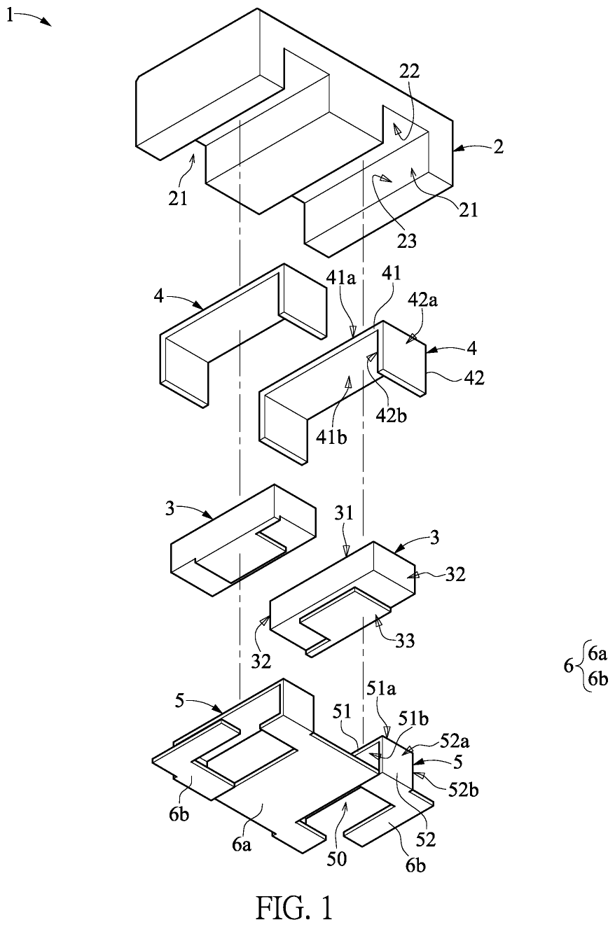

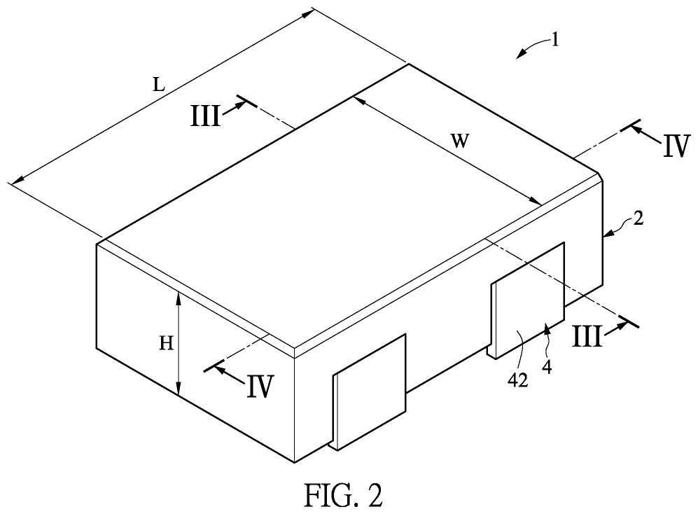

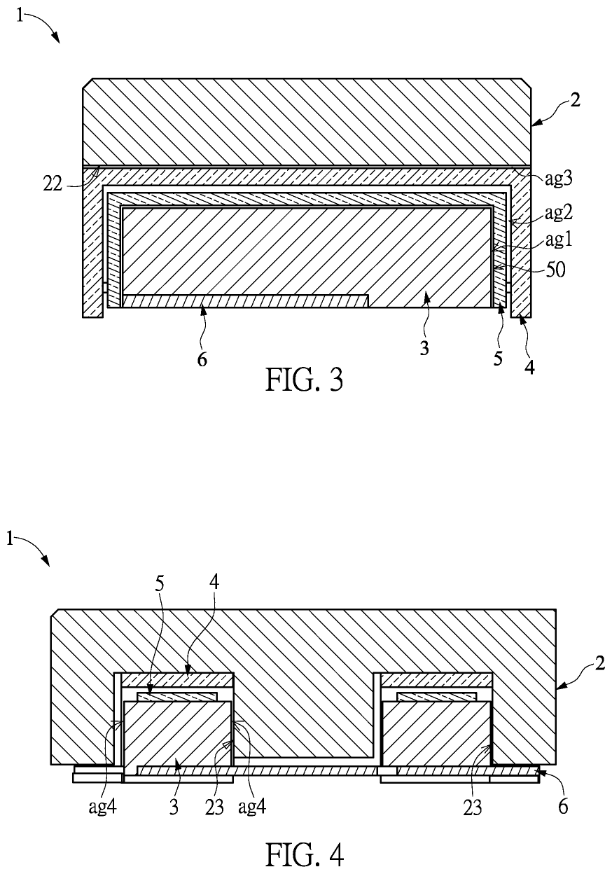

Referring to FIG. 1 to FIG. 4, FIG. 1 is an exploded schematic view of the first embodiment of the flat multi-phase inductor of the present disclosure; FIG. 2 is a combination schematic diagram of the first embodiment of the flat multi-phase inductor of the present disclosure; FIG. 3 is a schematic cross-sectional view of the section III-III of FIG. 2; and FIG. 4 is a schematic cross-sectional view of the IV-IV section of FIG. 2. As shown in FIG. 1, a flat multi-phase inductor 1 includes a main iron core 2 having a plurality of accommodating spaces 21, a plurality of first coils 4, a plurality of second coils 5 and a plurality of secondary iron cores 3. The plurality of first coils 4 are respectively disposed in the plurality of accommodating spaces 21, the plurality of second coils 5 are respectively disposed in spaces defined by the plurality of first coils 4, the plurality of secondary iron cores 3 are respectively disposed in spaces defined by the plurality of second coils 5. The plurality of secondary iron cores 3, the plurality of second coils 5 and the plurality of first coils 4 are correspondingly disposed in the plurality of accommodating spaces 21 of the main iron core 2 to form an inductor element. In practice, the material of the main iron core 2 and the plurality of secondary iron cores 3 may be, but not limited to, ferrite or other soft magnetic materials. The main iron core 2 can be an E-shaped or M-shaped iron core, and the plurality of secondary iron cores 3 can be an I-shaped iron core, which is not limited in the present disclosure.

In the first embodiment, each of the plurality of secondary iron cores 3 has an assembly surface 31 and two assembly sides 32, each of the plurality of first coils 4 has a first cross beam 41, each of two ends of the first cross beams 41 has a first cross beam extension part 42 bent perpendicular to a direction of the first cross beam 41, each of the plurality of second coils 5 has a second cross beam 51, each of two ends of the second cross beams 51 has a second cross beam extension part 52 bent perpendicular to a direction of the second cross beam 51. In practice, the plurality of first coils 4 and the plurality of second coils 5 can be made of copper sheets or conductive materials by stamping or bending, and the plurality of first coils 4 can be gate-shaped or [symbol] -shaped coils.

Further, the first cross beam 41 of the first coils 4 has a first cross beam outer surface 41a and a first cross beam inner surface 41b, the first cross beam extension parts 42 has a first cross beam extension part outer surface 42a and a first cross beam extension part inner surface 42b; the second cross beam 51 of the second coil 5 has a second cross beam outer surface 51a and a second cross beam inner surface 51b, and the second cross beam extension parts 52 has a second cross beam extension part outer surface 52a and a second cross beam extension part inner surface 52b.

Preferably, the second coil 5 includes at least one series part 6, the series part 6 has a series part body 6a and a plurality of lead-out portions 6b, the series part 6 connects the adjacent second coils 5 to each other in a regular manner, that is, the series part 6 can, but not limited to, connect the adjacent second coils 5 to each other at equal intervals, and a plurality of second coil accommodating spaces 50 is correspondingly defined by the series part 6 and the second coils 5. The plurality of secondary iron cores 3 are respectively disposed in the plurality of second coil accommodating spaces 50.

An assembly method of the flat multi-phase inductor according to the first embodiment of the present disclosure is as the followings.

The assembly surface 31 of each of the secondary iron cores 3 complements with the corresponding second cross beam inner surfaces 51b of the second coils 5, the two assembly sides 32 of each of the plurality of secondary iron cores 3 respectively complements with corresponding pair of the second cross beam extension part inner surface 52b of the second coils 5; the secondary cross beam outer surface 51a of the secondary iron cores 5 complements with the corresponding first cross beam inner surfaces 41b of the first coils 4, and the two second cross beam extension part outer surfaces 52a of each of the second coils 5 respectively complements with the corresponding pair of the first cross beam inner surface 42b of the each of the plurality of first coils 4. Each of the plurality of accommodating spaces 21 has an accommodating space inner wall 22, the first cross beam outer surface 41a of the first cross beam 41 of the first coils 4 complements with the corresponding accommodating space inner wall 22.

Each of the secondary iron cores 3 has an assembly member 33, and the assembly member 33 is correspondingly installed on the series part 6. The series part 6 has a series part body 6a and two lead-out portions 6b. The series part body 6a of the series part 6 connects the corresponding second cross beam extension part 52 of any two adjacent second coils 5, and the lead-out portions 6b of the series part 6 lead out the other corresponding second cross beam extension part 52 of any two adjacent second coils 5 toward the opposite side.

In some embodiments, the corresponding second cross beam extension part 52 of any two adjacent second coils 5 may only be connected to each other by the series part body 6a. In some embodiments, any two adjacent second coils 5 may only have the lead-out portions 6b. In some embodiments, any two adjacent second coils 5 may not be connected to each other by the series part 6. The flat multi-phase inductor 1 of the present disclosure can be a two-phase inductor, a three-phase inductor or a four-phase inductor, the present disclosure is not limited thereto.

As shown in FIG. 2, the flat multi-phase inductor 1 of the first embodiment of the present disclosure is a two-phase inductor. A height H of the flat multi-phase inductor 1 of the present disclosure is much smaller than a length L and width W of the flat multi-phase inductor 1, but it can be adjusted according to user needs or practical applications. For example, the height H can be less than or equal to the length L and width W of the flat multi-phase inductor 1 of the present disclosure, as long as the flat multi-phase inductor 1 is stable during operation without collapse or displace easily, the present disclosure is not limited thereto.

As shown in FIG. 3, each of the accommodating spaces 21 has an accommodating space inner wall 22, the first cross beam outer surface 41a of the first cross beam 41 of each of the plurality of first coils 4 cooperates with the corresponding accommodating space inner wall 22, each of the secondary iron cores 3 and the corresponding second coils 5 has a first gap ag1 therebetween, each of the second coils 5 and the corresponding first coils 4 has a second gap ag2 therebetween, and each of the first coils 4 and the corresponding accommodating spaces 21 has a third gap ag3 therebetween.

As shown in FIG. 4, each of the accommodating spaces 21 has two accommodating space inner side walls 23, each of the secondary iron cores 3 and the corresponding accommodating space inner side wall 23 has a fourth gap ag4 therebetween. Through the fourth gap ag4, the magnetic circuit of the inductor can be affected and the inductor can be adjusted. The present disclosure does not limit the type, filler and width of the gaps. Basically, the main iron core 2 and the first coil 4 can be regarded as one group, and the secondary iron core 3 and the second coil 5 can be regarded as another group, and the two groups are insulated from each other. Preferably, the main iron core 2, the first coil 4, the secondary iron core 3 and the second coil 5 are insulated from each other. The way of insulation is not limited in the present disclosure, it can be coating with an insulating layer or an insulating material.

### Second Embodiment

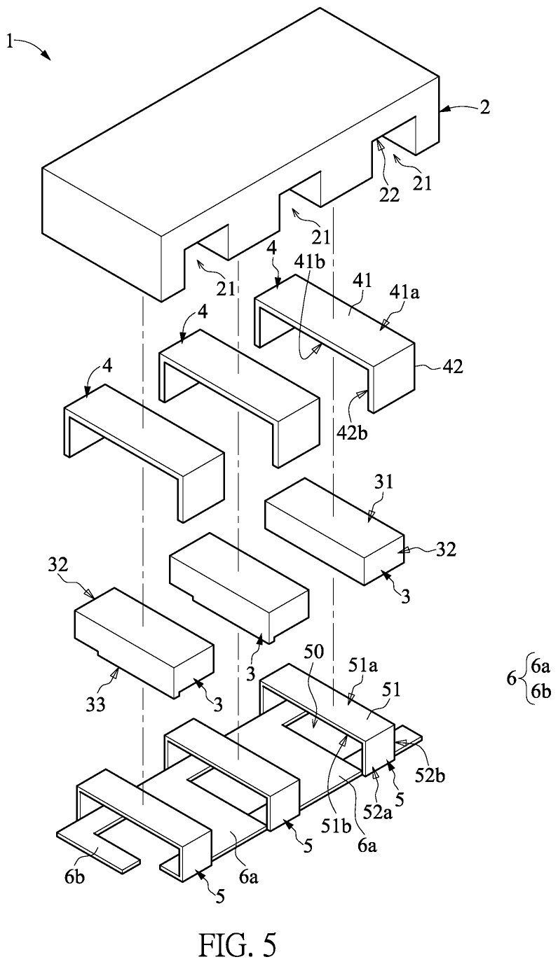

FIG. 5 is an exploded schematic diagram of a second embodiment of the flat multi-phase inductor of the present disclosure. In the second embodiment, the flat multi-phase inductor is a three-phase inductor. A structure of the main iron core 2 shown in FIG. 5 is substantially the same as that of the main iron core 2 shown in FIG. 1. The difference between the main iron core 2 shown in FIG. 5 and the main iron core 2 shown in FIG. 1 is that, the main iron core 2 shown in FIG. 5 includes three accommodating spaces 21, three first coils 4, three second coils 5 and three secondary iron cores 3. The three first coils 4 are respectively disposed in the three accommodating spaces 21, the three second coils 5 are respectively disposed in spaces defined by the three first coils 4; the three secondary iron cores 3 are respectively disposed in spaces defined by the three second coils 5. The three secondary iron cores 3, the three second coils 5 and the three first coils 4 are correspondingly disposed in the three accommodating spaces 21 of the main iron core 2 to form an inductor element. An assembly method of the above components is the same as the assembly method of the first embodiment shown in FIGS. 1 to 4, and will not be repeated here.

Similarly, each of the secondary iron cores 3 and the corresponding second coils 5 has a first gap ag1 therebetween, each of the second coils 5 and the corresponding first coils 4 has a second gap ag2 therebetween, and each of the first coils 4 and the corresponding accommodating spaces 21 has a third gap ag3 therebetween.

Similarly, each of the accommodating spaces 21 has two accommodating space inner side walls 23, each of the secondary iron cores 3 and the corresponding accommodating space inner side wall 23 has a fourth gap ag4 therebetween. Through the fourth gap ag4, the magnetic circuit of the inductor can be affected and the inductor can be adjusted. The present disclosure does not limit the type, filler and width of the gaps.

Preferably, the second coil 5 includes a series part 6, the series part 6 has a series part body 6a and a plurality of lead-out portions 6b, the series part 6 connects the adjacent second coils 5 to each other in a regular manner, that is, the series part 6 can, but not limited to, connect the adjacent second coils 5 to each other at equal intervals. The second coil accommodating space 50 is formed by the series part 6 and the second coil 5, and the three secondary iron cores 3 are respectively disposed in the three second coil accommodating spaces 50.

### Third Embodiment

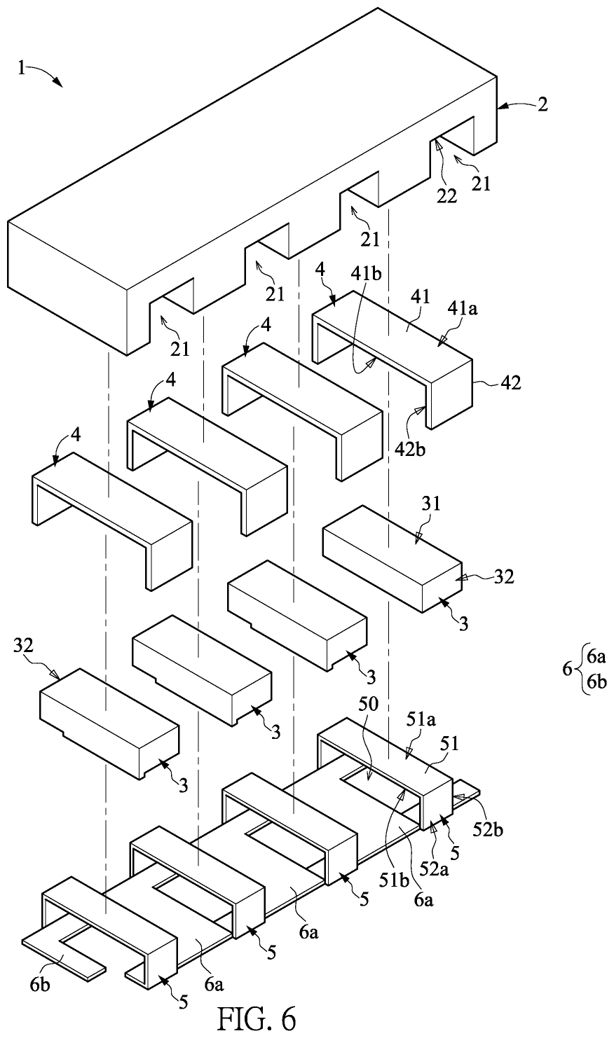

FIG. 6 is an exploded schematic view of a third embodiment of the flat multi-phase inductor of the present disclosure. In the third embodiment, the flat multi-phase inductor is a four-phase inductor. A structure of the main iron core 2 shown in FIG. 6 is substantially the same as that of the main iron core 2 shown in FIG. 1. The difference between the main iron core 2 shown in FIG. 6 and the main iron core 2 shown in FIG. 1 is that, the main iron core 2 shown in FIG. 6 includes four accommodating spaces 21, four first coils 4, four second coils 5 and four secondary iron cores 3. The four first coils 4 are respectively disposed in the four accommodating spaces 21, the four second coils 5 are respectively disposed in spaces defined by the four first coils 4, the four secondary iron cores 3 are respectively disposed in spaces defined by the four second coils 5. The four secondary iron cores 3, the four second coils 5 and the four first coils 4 are correspondingly disposed in the four accommodating spaces 21 of the main iron core 2 to form an inductor element. An assembly method of the above components is the same as the assembly method of the first embodiment shown in FIGS. 1 to 4, and will not be repeated here.

Similarly, each of the secondary iron cores 3 and the corresponding second coils 5 has a first gap ag1 therebetween, each of the second coils 5 and the corresponding first coils 4 has a second gap ag2 therebetween, each of the first coils 4 and the corresponding accommodating spaces 21 has a third gap ag3 therebetween.

Similarly, each of the accommodating spaces 21 has two accommodating space inner side walls 23, each of the secondary iron cores 3 and the corresponding accommodating space inner side wall 23 has a fourth gap ag4 therebetween. Through the fourth gap ag4, the magnetic circuit of the inductor can be affected and the inductor can be adjusted. The present disclosure does not limit the type, filler and width of the gaps.

Preferably, each of the second coil 5 includes a series part 6, the series part 6 has a series part body 6a and a plurality of lead-out portions 6b, the series part 6 connects the adjacent second coils 5 to each other in a regular manner, that is, the series part 6 can, but not limited to, connect the adjacent second coils 5 to each other at equal intervals. The second coil accommodating space 50 is formed by the series part 6 and the second coil 5, and the four secondary iron cores 3 are respectively disposed in the four second coil accommodating spaces 50.

### Fourth Embodiment

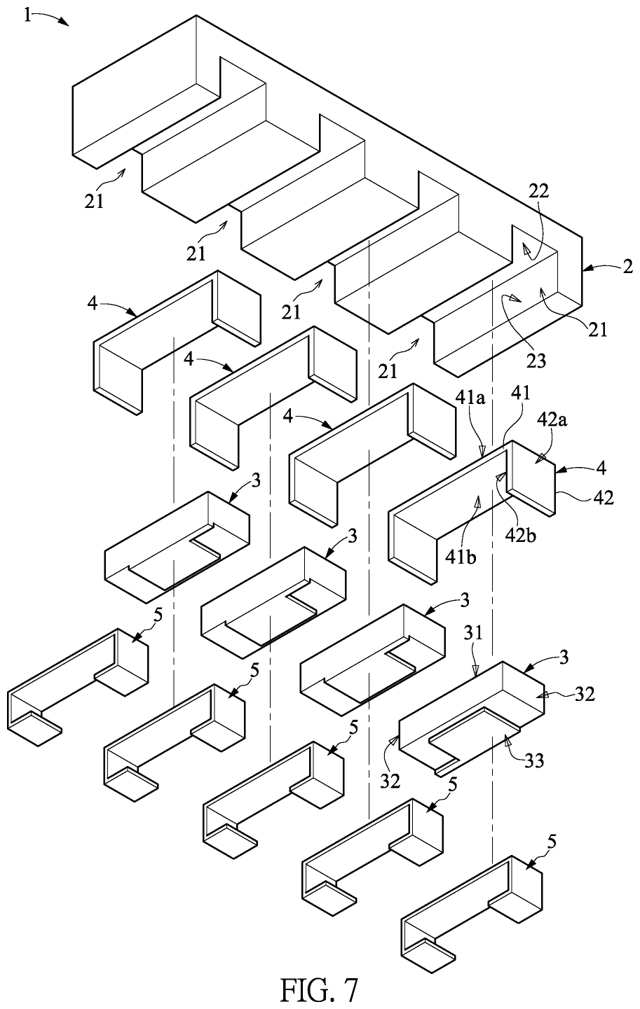

FIG. 7 is an exploded schematic view of a fourth embodiment of the flat multi-phase inductor of the present disclosure. A structure of the main iron core 2 shown in FIG. 7 is substantially the same as that of the main iron core 2 shown in FIG. 6. The difference between the main iron core 2 shown in FIG. 7 and the main iron core 2 shown in FIG. 6 is that, the main iron core 2 shown in FIG. 7 doesn't include the series part 6.

### Beneficial Effects of the Embodiments

One of the beneficial effects of the present disclosure is that, in the flat multi-phase inductor provided by the present disclosure by virtue of “the height of the flat multi-phase inductor is smaller than the length or the width of the flat multi-phase inductor”, stability of the flat multi-phase inductor during operation can be achieved, and the flat multi-phase inductor is not easy to collapse or displace. Another beneficial effect is that, the reliability of the overall flat multi-phase inductor is increased through the technical solution of “connecting the plurality of second coils to each other in a regular manner by the series part of the plurality of second coils”.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A flat multi-phase inductor, comprising:
a main iron core having a plurality of accommodating spaces;
a plurality of first coils respectively disposed in the plurality of accommodating spaces;
a plurality of second coils respectively disposed in spaces defined by the plurality of first coils;
a plurality of secondary iron cores respectively disposed in spaces defined by the plurality of second coils;
wherein the plurality of secondary iron cores, the plurality of second coils and the plurality of first coils are correspondingly disposed in the plurality of accommodating spaces of the main iron core to form an inductor element.

2. The flat multi-phase inductor according to claim 1, wherein each of the plurality of secondary iron cores has an assembly surface and two assembly sides, each of the plurality of first coils has a first cross beam, each of two ends of the first cross beams has a first cross beam extension part bent perpendicular to a direction of the first cross beam; each of the plurality of second coils has a second cross beam, each of two ends of the second cross beams has a second cross beam extension part bent perpendicular to a direction of the second cross beam.

3. The flat multi-phase inductor according to claim 2, wherein the first cross beam of the first coil has a first cross beam outer surface and a first cross beam inner surface, the first cross beam extension part has a first cross beam extension part outer surface and a first cross beam extension part inner surface, the second cross beam of the second coil has a second cross beam outer surface and a second cross beam inner surface, and the second cross beam extension part has a second cross beam extension part outer surface and a second cross beam extension part inner surface.

4. The flat multi-phase inductor according to claim 3, wherein the assembly surface of each of the secondary iron cores complements with a corresponding one of the second cross beam inner surfaces of the second coils, the two assembly sides of each of the plurality of secondary iron cores respectively complements with a corresponding pair of the second cross beam extension part inner surfaces of the second coils, the secondary cross beam outer surface of each of secondary iron cores complements with a corresponding one of the first cross beam inner surfaces of the first coils, and the two second cross beam extension part outer surfaces of each of the second coils respectively complements with a corresponding pair of the first cross beam inner surfaces of the first coils.

5. The flat multi-phase inductor according to claim 3, wherein each of the plurality of accommodating spaces has an accommodating space inner wall and two accommodating space inner side walls, and the first cross beam outer surface of the first coils complements with a corresponding one of the accommodating space inner wall.

6. The flat multi-phase inductor according to claim 5, wherein each of the plurality of secondary iron cores and a corresponding one of the second coils has a first gap therebetween, each of the plurality of second coils and a corresponding one of the first coils has a second gap therebetween, each of plurality of the first coils and a corresponding one of the accommodating spaces has a third gap therebetween, and each of the plurality of secondary iron cores and a corresponding one of the accommodating space inner side walls has a fourth gap therebetween.

7. The flat multi-phase inductor according to claim 1, wherein the plurality of first coils and the plurality of second coils are made of a copper sheet or a conductive material by stamping or bending, and wherein the plurality of first coils are gate-shaped or [symbol] -shaped coils.

8. The flat multi-phase inductor according to claim 1, wherein each of the plurality of second coils includes at least one series part, the series part connects adjacent second coils to each other in a regular manner, a plurality of second coil accommodating spaces are correspondingly defined by the series part and the second coils, and each of the plurality of secondary iron cores are respectively disposed in the plurality of second coil accommodating spaces.

9. The flat multi-phase inductor according to claim 8, wherein each of the plurality of secondary iron cores has an assembly member, and the assembly member is correspondingly installed on the series part.

10. The flat multi-phase inductor according to claim 1, wherein the flat multi-phase inductor is a two-phase inductor, a three-phase inductor or a four-phase inductor.

11. The flat multi-phase inductor according to claim 1, wherein a height of the flat multi-phase inductor is smaller than a length or a width of the flat multi-phase inductor.
